(19) United States
(12) Patent Application Publication
(10) Pub. No.: US 2022/0213988 A1
(43) Pub. Date: Jul. 7, 2022

(54) Systems and Methods for a Strut Clip

(71) Applicant: ERICO International Corporation, Solon, OH (US)

(72) Inventors: Jeffrey Alan Wilson, Cuyahoga Falls, OH (US); Nathan Joseph Petek, Chagrin Falls, OH (US); Eric J. Wilson, Solon, OH (US)

(21) Appl. No.: 17/569,714

(22) Filed: Jan. 6, 2022

Related U.S. Application Data
(60) Provisional application No. 63/134,278, filed on Jan. 6, 2021.

(51) Int. Cl. F16L 3/24; F16B 2/24

(52) U.S. Cl. CPC F16L 3/2431; F16B 2/243

(57) ABSTRACT

A clip is provided for supporting a cylindrical object on a strut channel. The clip can include a clip body extending along a clip axis and can have a first end with a notch. The notch can be sized to receive a cylindrical object during installation of the clip to the strut channel when the clip body is positioned around the cylindrical object with the clip axis obliquely angled relative to a longitudinal axis of the cylindrical object. The clip can also have a first set of arms extending from the first end of the clip body adapted to engage a first reentrant lip of a strut channel when the cylindrical object is received in the notch and a second set of arms extending from a second end of the clip body adapted to be resiliently flexible for engagement with a second reentrant lip of the strut channel.

### CROSS-REFERENCE TO RELATED APPLICATIONS

This application claims priority under 35 U.S.C. 119 from U.S. Provisional Application No. 63/134,278, filed Jan. 6, 2021, entitled “Systems and Methods for a Strut Clip,” and is incorporated herein by reference in its entirety.

### BACKGROUND

In many applications it may be useful to support objects on a strut channel. For example, it may be useful to support raceways, conduit, including electric metallic tube (EMT) conduit, or cable, including metal clad (MC) cable and cable for data transmission, on a strut channel. In some contexts, other types of pipes, for instance, plumbing or gas pipes, need to be supported on strut channel.

### SUMMARY

Some embodiments of the invention provide a clip for supporting a cylindrical object with a longitudinal axis on a strut channel with a pair of reentrant lips. The clip can include a clip body extending along a clip axis and can have a first end with a notch and a second end. The notch can be sized to receive a cylindrical object during installation of the clip to the strut channel when the clip body is positioned around the cylindrical object with the clip axis obliquely angled relative to a longitudinal axis of the cylindrical object. A first set of arms can extend in a first direction from the first end of the clip body, with each arm of the first set including a first hook adapted to engage a first reentrant lip of a strut channel when the cylindrical object is received in the notch. A second set of arms can extend in the first direction from the second end of the clip body, each arm of the second set being resiliently flexible to be moved into engagement with a second reentrant lip of the strut channel by contact with the strut channel as, with the first set of arms engaging the first reentrant lip, the clip body can be rotated to move the second end of the clip body toward the strut channel.

Some embodiments provide a clip for supporting a cylindrical object with a longitudinal axis to a strut channel with a pair of reentrant lips. The clip can include a clip body extending along a clip axis that can be configured to be parallel to a longitudinal axis of a cylindrical object secured by the clip body to a strut channel. The clip body can have a first end and a second end; a set of hooks, including a first hook and a second hook, extending from the first end of the clip body in a first direction; and a set of arms, including a first arm and a second arm, extending from the second end of the clip body in the first direction. The set of arms can be configured to be bendable toward the first end of the clip body along the direction of the clip axis under contact with the strut channel as the clip body is rotated toward an installed orientation on the strut channel. The set of hooks can be configured to be rigid against bending toward the second end of the clip body along the direction of the clip axis under contact with the strut channel as the clip body is rotated toward the installed orientation.

Some embodiments provide a method for securing a cylindrical object with a longitudinal axis to a strut channel with a strut axis. The strut channel can have an open side with a first reentrant lip and a second reentrant lip that extend in parallel with the strut axis. The method can include positioning the cylindrical object across and adjacent the open side of the strut channel, with the longitudinal axis perpendicular to the strut axis. The method can further include aligning an integrally formed clip with the cylindrical object, with a first set of arms that depend from a first end of a clip body of the clip on opposing sides of the cylindrical object. The first hooks of the first set of arms can be engaged with the first reentrant lip of the strut channel, with the cylindrical object received within a notch that extends axially into the clip body, and with a clip axis defined by the clip body obliquely angled relative to the longitudinal axis of the cylindrical object. With the first hooks engaged with the first reentrant lip, the clip can be rotated relative to the cylindrical object, about the engagement of the first hooks with the first reentrant lip, to move a second end of the clip body toward the strut channel and cause a second set of arms to be resiliently flexed toward the first end of the clip body by contact with the strut channel to be moved into engagement with the second reentrant lip to secure the cylindrical object to the strut channel. Additionally, a set of arms extending from the second end of the body can be engaged with the second reentrant lip of the strut channel.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front isometric view of a clip according to an embodiment of the invention securing a cylindrical object to a strut channel;

FIG. 2 is a front isometric view of the clip of FIG. 1;

FIG. 3 is a rear isometric view of the clip of FIG. 1;

FIG. 4 is a rear isometric view of the clip of FIG. 1;

FIG. 5 is a side elevation view of the clip of FIG. 1;

FIG. 6 is a rear elevation view of the clip of FIG. 1;

FIG. 7 is a top plan view of the clip of FIG. 1;

FIG. 8 is a front isometric view of a clip assembly according to an embodiment of the invention with the clip of FIG. 1 and a collar securing a cylindrical object to a strut channel;

FIG. 9 is a front isometric view of the collar of FIG. 8;

FIGS. 10-15 illustrate installation steps for securing a cylindrical object to a strut channel with the clip of FIG. 1 according to another embodiment of the invention;

FIG. 16 is a front isometric view of a clip according to another embodiment of the invention;

FIG. 17 is a rear isometric view of the clip of FIG. 16;

FIG. 18 is a rear isometric view of the clip of FIG. 16;

FIG. 19 is a side elevation view of the clip of FIG. 16;

FIG. 20 is a rear elevation view of the clip of FIG. 16; and

FIG. 21 is a top plan view of the clip of FIG. 16.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise defined or limited, directional terms are used for convenience of reference for discussion of particular figures or examples. For example, references to downward (or other) directions may be used to discuss aspects of a particular example or figure, but do not necessarily require similar orientation or geometry in all installations or configurations.

Also as used herein, unless otherwise defined or limited, “substantially planar” indicates a component that extends within a plane over a majority of the length of the component. A component may include deviations from the plane as formed by support ribs or recesses, detents and corresponding recesses, and other similar features while still remaining substantially planar.

Also as used herein, unless otherwise defined or limited, the term “lateral” refers to a direction that extends at least partly to a left or a right side of a reference line. Accordingly, for example, a lateral direction can sometimes be a radial or other generally perpendicular direction relative to an axial, elongate, or other reference direction defined by a body (e.g., a direction in which an axis of a cylindrical object extends when secured to a support structure by a clip body).

Also as used herein, unless otherwise limited or defined, “integral” and derivatives thereof (e.g., “integrally”) describe elements that are manufactured as a single piece without fasteners, adhesive, or the like to secure separate components together. For example, an element stamped as a single-piece component from a single piece of sheet metal, without rivets, screws, or adhesive to hold separately formed pieces together is an integral (and integrally formed) element. In contrast, an element formed from multiple pieces that are separately formed initially then later connected together, is not an integral (or integrally formed) element.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes a clip that engages with a strut channel to secure a cylindrical object thereto without the use of fasteners or tools. The context and particulars of this discussion are presented as examples only. For example, embodiments of the disclosed invention can be configured in various ways, including with other shapes and arrangements of elements. Similarly, embodiments of the invention can be used with arrangements of elongate objects having cross-sections other than cylindrical and to support systems other than strut channel. The context and particulars of this discussion are presented as examples only.

Cylindrical objects, such as electrical conduit, pipes, and the like can sometimes be secured to strut channel for support. The support can be overhead, vertical or horizontal along a wall, along the ground, or any other orientation. The support may be required at certain distances by code depending on the orientation. Installing numerous clamps by hand requiring fasteners to be aligned and tightened with tools can be time consuming and arduous.

Conventional arrangements for securing can include multiple pieces that need to be individually installed within the strut channel on both sides of the cylindrical object, after which a fastener, typically a bolt, is received by both pieces and secured by tightening with a nut. With these types of clamps, especially if installed over head, the user may be required to perform much of the labor with hands above the head. With the numerous parts and tools required, there is also a greater potential for dropping the parts and tools, potentially leading to lost pieces, delayed installation, or other issues.

Embodiments of the invention can address these or other issues. For example, in some embodiments, a clip can be an integrally formed unitary piece with no fasteners or tools needed for installation. Providing a one-piece and fastener-less clip can be beneficial in many contexts. For example, cylindrical objects can be secure to strut channel with little to zero effort other than holding the cylindrical object in place (as needed) and pushing the clip into engagement with the strut channel to secure the cylindrical object.

In some embodiments, a clip can have a hook extending from one end of a body and an arm with a barb from the other end of the body. The body can receive a cylindrical object to be secured to a strut channel. The hook can engage with one reentrant lip of the strut channel and the arm can engage the other reentrant lip. In some embodiments, the hook can be engaged first and the clip can be rotated at the hook relative to (e.g., about) the reentrant lip to then engage the arm with the other reentrant lip. In some embodiments, the body of the clip can include spring grips that extend inward from an inner surface of the body that biasingly engage with the cylindrical object to maintain engagement of the clip to the strut channel and securement of the cylindrical object.

In some embodiments, the clip can have a set of arms and a set of hooks depending from the body of the clip. The sets of arms and the sets of hooks can secure to each reentrant lip of the strut channel on both sides of the cylindrical object.

In some embodiments, the clip can be formed form a resilient material (e.g., spring steel), such that during installation of the clip onto the strut channel, the arm of the clip can resiliently flex to allow the arm to pass into the strut channel and rebound to engage the barb with the relevant lip.

In some embodiments, a clip assembly can include a clip and a collar. The collar can be positioned between the clip and the cylindrical object to provide an insulative barrier. The collar can be formed to tighten around the cylindrical object as the clip is installed around the collar and the cylindrical object and to the strut channel. In some embodiments, the collar can be formed from a polymeric material. In some embodiments, the collar can provide at least one of electrical, thermal, or galvanic insulation.

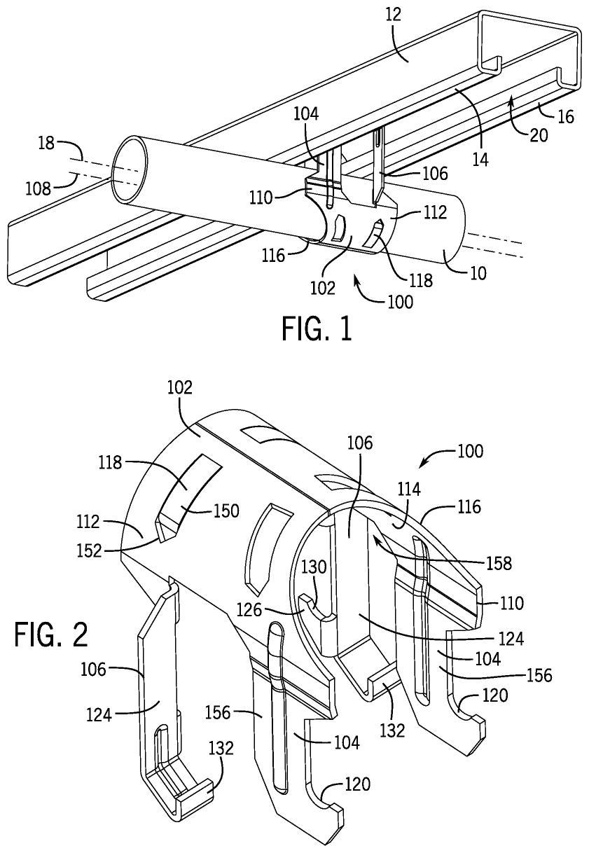

FIG. 1 illustrates an example clip 100 according to an embodiment of the present invention. The clip 100 is shown securing a cylindrical object 10 to a strut channel 12 having an open side 20 with a first reentrant lip 14 and a second reentrant lip 16. Examples of cylindrical objects include, electrical conduit, polyvinyl chloride (PVC) pipe, steel pipe, copper pipe, etc. In the illustrated embodiment, the strut channel 12 is shown opening in a downward direction, although a variety of other orientations are possible. Similarly, although the strut channel 12 exhibits a standard strut profile, some embodiments can be configured to engage other types of strut or channeled support structures generally.

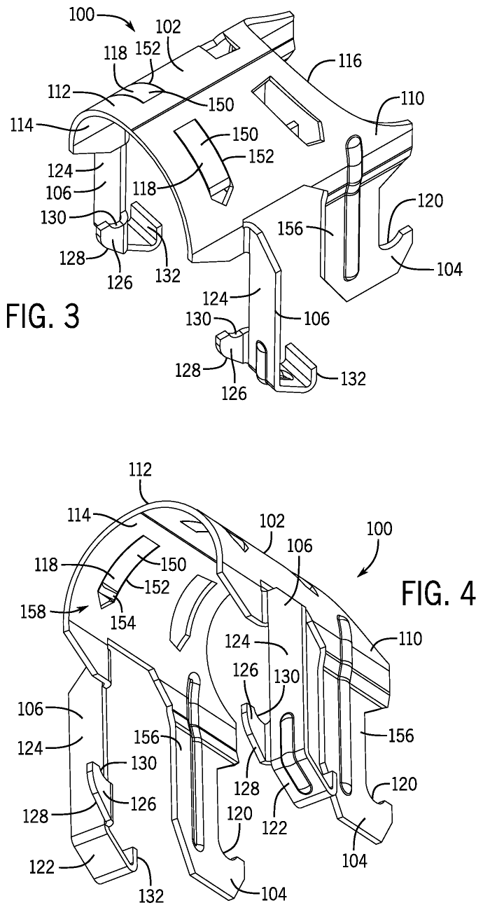

FIGS. 2 through 6 show the clip 100 in isolation. The clip 100 includes a clip body 102 with a set of arms at a first end thereof (here shown with a pair of hooks 104) and a set of arms at a second end thereof (here shown with a pair of arms 106) extending from the clip body 100. In the illustrated embodiment, the clip 100 is a unitary object, formed from one-piece of material (e.g., as an integral stamping), however, it is contemplated that a clip according to another embodiment can be formed from an assembly of individual pieces. The clip 100 can be formed from a resilient material, such as spring steel, for example.

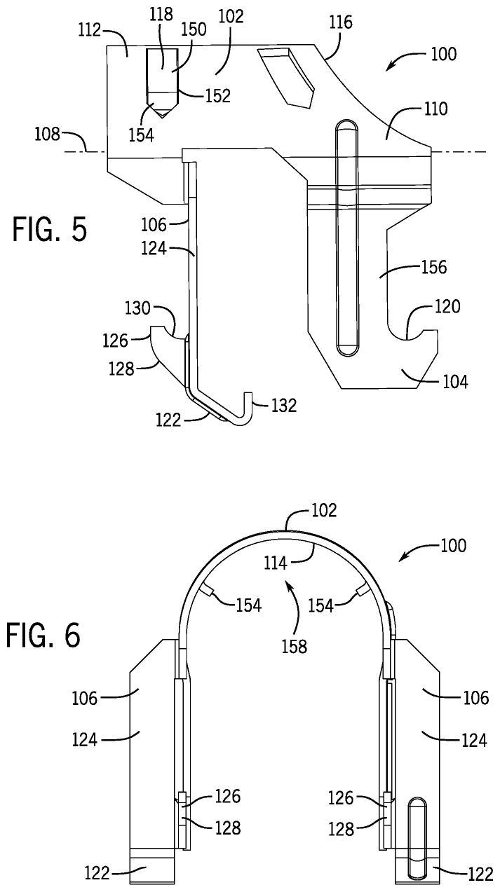

Continuing, the clip body 102 extends along a clip axis 108 (FIGS. 1 and 5) from a first end 110 to a second end 112. The clip body 102 has an inner surface 114 that forms a saddle 158 to receive (e.g., seat) a secured object. The inner surface 114 is configured to have an inner radius similar to, if not slightly larger than, the outer radius of a cylindrical object (e.g., the cylindrical object 10 shown in FIG. 1) being secured. Correspondingly, in the illustrated example, the inner surface 114 is hemi-cylindrically shaped (i.e., includes a semi-circular cross section in a plane perpendicular to the clip axis 108), so as to closely engage a circular pipe profile. Embodiments of a clip according to the invention can be sized to accommodate different sizes of cylindrical objects or other elongate objects to be secured to strut. In the embodiment shown, the clip body 102 also has an overall hemi-cylindrical shape with extension portions (e.g., planar extensions as shown in FIGS. 5 and 6, in particular) that can extend tangentially from opposing sides of the saddle to further bound an interior area of the body 102. However, other forms are contemplated. For example, a clip body overall or an inner surface of a clip portion thereof can exhibit other partial-cylindrical profiles or profiles that are not cylindrical (e.g., V-shaped profiles that are acutely or otherwise angled).

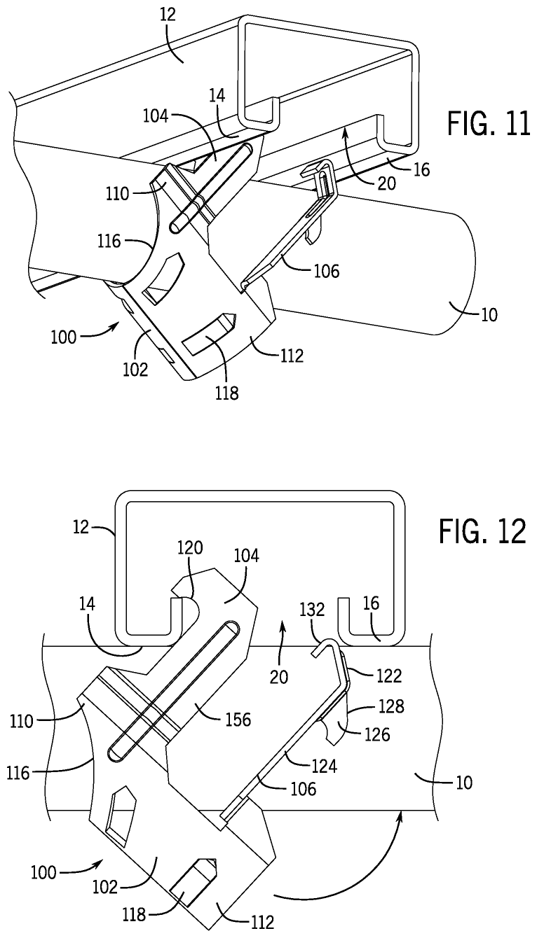

In some cases, arms at a first end of a clip can be spaced to engage the corresponding (e.g., first) reentrant lip at locations that are laterally to the outside of locations at which arms at a second end of the clip engage the corresponding opposing (e.g., second) reentrant lip. Also as shown in FIG. 6 in particular, for example, the arms 106 extend laterally to the outside of the hooks 104 from a perspective in parallel with the clip axis 108 (see FIG. 5). Correspondingly, as also illustrated in FIG. 11, the arms 106 can engage lips of a strut laterally to the outside (at least in part) of the hooks 104.

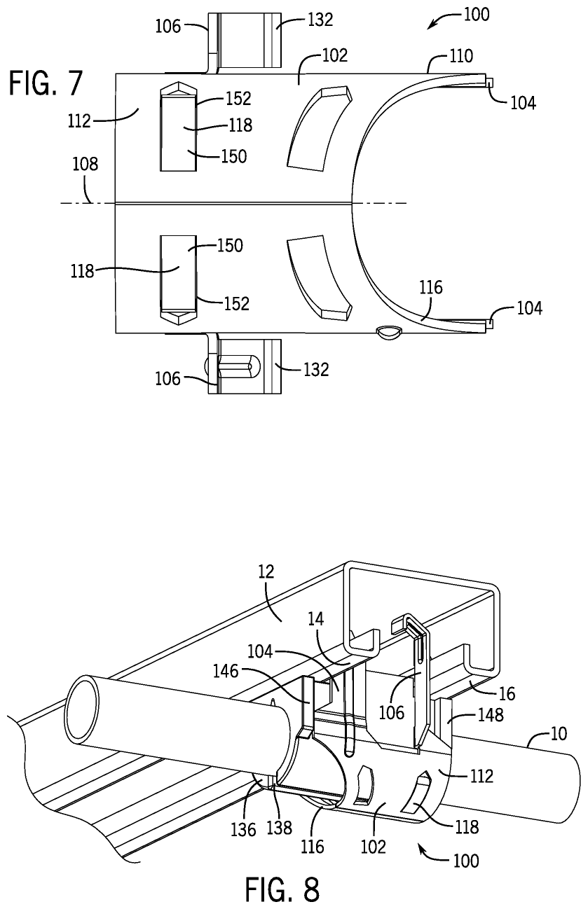

In some embodiments, additional features can be included in the clip 100 that can be helpful during installation of the clip 100. In some embodiments, a notch can extend into a body of a clip (e.g., a saddle of the body) so that the clip can be rotated relative to a received cylindrical object without significantly withdrawing the clip away from a strut to which the cylindrical object is (or is to be) supported. For example, a notch 116 extends into the clip body 102 from the first end 110. In particular, in the illustrated example, the notch 116 defines a generally crescent shaped (e.g., radiused) concave profile that extends into the saddle 158 in a direction that is parallel to the clip axis 108, as viewed from above or the side (as shown in FIGS. 5 and 7). The notch 116, or other similarly placed notches can help to accommodate a cylindrical object (e.g., the cylindrical object 10 shown in FIG. 1) during the installation of the clip 100 and thereby substantially increase ease of installation as compared to conventional designs (e.g., as discussed further below with respect to FIGS. 10 through 15). For example, in some embodiments, the saddle 158 can define a saddle radius that corresponds to a radius of the cylindrical object 10, and the notch 116 can extend into the saddle 158 in the direction of the clip axis 108 by at least the saddle radius. Thus, in this example, the notch 116 can accommodate half of the outer periphery of the cylindrical object 10 during installation of the clip 100.

In the illustrated example, the clip 100 also has at least one spring grip 118 extending inward from the clip body 102 in the direction of the sets of hooks and arms 104, 106. The spring grip 118 is integrally formed with the clip body 102. The spring grip 118 is configured to be biased inward to make contact with a cylindrical object, such as, for example, the cylindrical object 10 shown in FIG. 1 when installed. The spring grip 118 can increase the securing force exerted on the cylindrical object 10 to aid in securing the cylindrical object 10 within the clip 100. In the illustrated embodiment, the spring grip 118 includes an integrally formed resilient tab 150 that extends inward from a closed slot 152 in the clip body 102 and terminates with a tooth 154 extending from the resilient tab 150 toward the clip axis 108, although other configurations are also possible

In the illustrated embodiment, the hooks 104 can extend tangentially from the clip body 102. The hooks 104 extend opposite each other from the first end 110 of the clip body 102. As shown in FIG. 5, the hooks 104 extend in a first direction from the clip body 102 perpendicular to the clip axis 108. The hooks 104 are configured to engage the first reentrant lip 14 of the strut channel 12. Each of the hooks 104 has a hook connecting portion 156 and a contact edge 120 that is curved (e.g., arcuate) and configured to contact the first reentrant lip 14 and allow pivoting of the clip 100 about the first reentrant lip 14. In some embodiments, such as the illustrated embodiment, the hooks 104 can be integrally formed with the clip body 102.

The arms 106 also extend tangentially from the clip body 102 in the illustrated embodiment. The arms 106 extend opposite each other from the second end 112 of the clip body 102. As shown in FIG. 5, the arms 106 extend in the first direction from the clip body 102 parallel to the hooks 104 and perpendicular to the clip axis 108. The arms 106 are configured to contact the second reentrant lip 16 of the strut channel 12 and guide the clip 100 into a securing position (shown in FIGS. 1 and 14). The arms 106 are configured to be resiliently flexible relative to the clip body 102 in directions along the clip axis 108 toward and away from the first end 110. In some embodiments, such as the illustrated embodiment, the arms 106 can be integrally formed with the clip body 102.

In the illustrated embodiment, the arms 106 each have a guiding surface 122 that is angled relative to an arm connecting portion 124 in a direction along the clip axis 108 toward the first end 110. The guiding surface 122 is configured to contact the second reentrant lip 16 during installation and direct (e.g., bend) the arm 106 inward of the strut channel 12. The arms 106 also each include a barb 126 extending from the arm connecting portion 124. The barb 126 is proximally located to the clip body 102 relative to the guiding surface 122 and extends from the arm connecting portion 124 in the direction opposite the guiding surface 122 (i.e., in a direction along the clip axis 108 away from the front end 110). The barb 126 is configured to continue the biasing of the arm 106 during engagement with the second reentrant lip 16 during installation of the clip 100. The barb 126 has an engagement edge 128 that is oriented to be an extension of the guiding surface 122 to encourage continued, uninterrupted, engagement with the second reentrant lip 16 as the clip 100 is being installed. The barb 126 also has a retention pocket 130 shaped (e.g., arcuate) and configured to engage and receive the second reentrant lip 16 when the clip 100 is in the securing position (shown in FIGS. 1 and 14).

As shown in FIGS. 5 and 6, in particular, an arm connecting portion planar orientation of the arm connecting portions 124 of the arms 106 is perpendicular to a hook connecting portion planar orientation of the hook connecting portions 156 of the hooks 104. Accordingly, the arms 106 may be more easily deformed along a direction in which the hooks 104 are relatively stiff (e.g., perpendicular to the plane of the arm connecting portions 124 and parallel to the plane of the hook connecting portions 156). As further discussed below, this allows the arms 106 to be readily deflected, as needed, during installation, while the hooks 104 remain rigid, ensuring that the hooks 104 and the arms 106 collectively provide sufficient retention strength relative to an engaged conduit or other object.

During installation of multiple cylindrical objects to a strut channel, there may be a need to conserve space along the strut channel. In the illustrated embodiment, the arms 106 are configured to flare outward from the clip body 102 (e.g., via the orientation of the planar arm connecting portions 124, as shown). The outward flare of the arms 106 can increase the resilient characteristic and aid in installation of the clip 100. Further, when installing multiple clips 100, adjacent clips can be rotated 180 degrees from each other to alternate the reentrant lip the arms engage and correspondingly orient the arm connecting portions 124 of adjacent clip bodies 102 on opposing sides of the respective supported object. The corresponding alignment of the hooks 104 of one clip with the arms 106 of another clip can provide increased clearance for the arms 106 and thereby allow the clips 100 to be more closely spaced along the strut channel 12.

In the case of removal of the clip 100 from the strut channel 12, some embodiments can include additional features that can aid such a task. A tab 132 can be provided at the distal end of the arm 106 extending in a second direction, opposite the first direction, back toward the clip body 102. The tab 132 can provide a location for a screwdriver (not shown) to urge the clip 100 further into the strut channel 12, or otherwise elastically deform the corresponding arm 106, to disengage the barb 126 from the second reentrant lip 16 and bias the arm 106 away from the second reentrant lip 16 to fully release the arm 106.

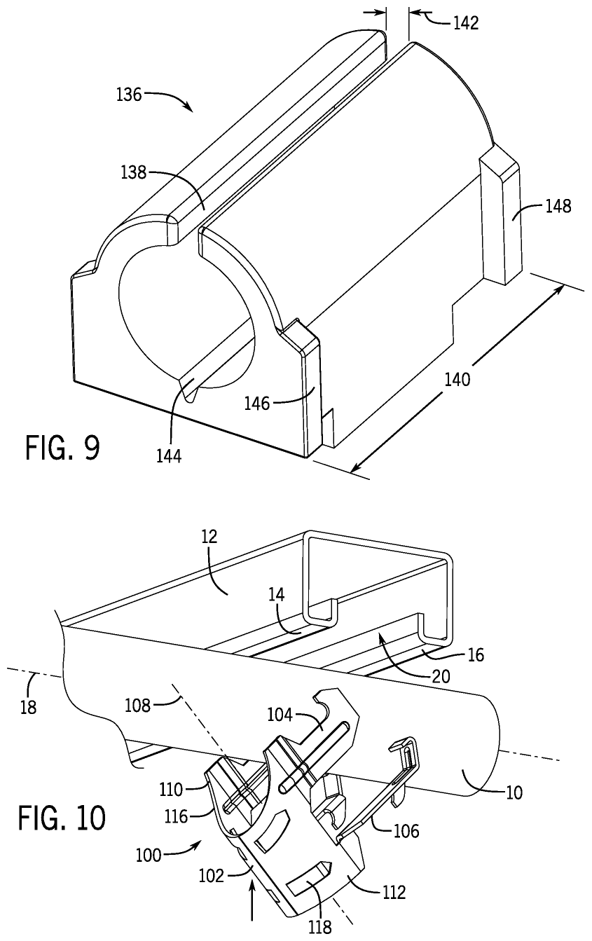

In some securing scenarios it may be preferable to isolate a cylindrical object (e.g., thermally, electrically, or galvanically) from a strut channel. FIGS. 8 and 9 illustrate an example embodiment of a collar 136 that can be installed around the cylindrical object 10 and within the clip 100 that isolates the cylindrical object 10 from the clip 100 and the strut channel 12. The collar 136 can be formed from a polymeric material with electrical and/or thermal insulative properties. The collar 136 has a slot 138 extending along the length 140 of the collar 136, defining a gap 142, and a groove 144 extending along the length of the collar 136 opposite the slot 138. The collar 136 is configured to open at the slot 138 to receive the cylindrical object 10 into the collar 136, with the groove 144 configured to provide some relief during the opening of the collar 136. Further, during securing and when in the securing position, the clip 100 can urge the collar 136 more tightly around the cylindrical object 10 by decreasing the gap 142. The collar 136 also can have shoulders 146, 148 at each end of the length 140 that can be configured to abut the hooks 104 and the arms 106 to maintain the placement of the collar 136 within the clip 100.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

For example, with reference to FIGS. 10 through 15, some embodiments can include a method by which a user can secure the cylindrical object 10 to the strut channel 12 with the clip 100. To secure the cylindrical object 10 to the strut channel 12, the user positions the cylindrical object 10 adjacent and across the open side 20 of the strut channel 12, with a longitudinal axis 18 (FIG. 10) of the cylindrical object perpendicular to the first and second reentrant lips 14, 16. The user angles the clip 100 relative to the cylindrical object 10 with the clip axis 108 oriented at an angle other than zero relative to the longitudinal axis 18, the first end 110 of the clip body 102 nearest the cylindrical object 10, and the hooks 104 along opposite sides of the cylindrical object 10 (FIG. 10). The clip 100 is positioned in a manner in which the clip axis 108, if extended beyond the clip body 102, intersects the longitudinal axis 18 of the cylindrical object 10 and is generally in a common plane with the axis 18. The user translates the clip 100 toward the strut channel 12 and inserts the hooks 104 within the strut channel 12 so that the contact edge 120 (see FIG. 12) of each hook 104 contacts the first reentrant lip 14 of the strut channel 12 (FIG. 11).

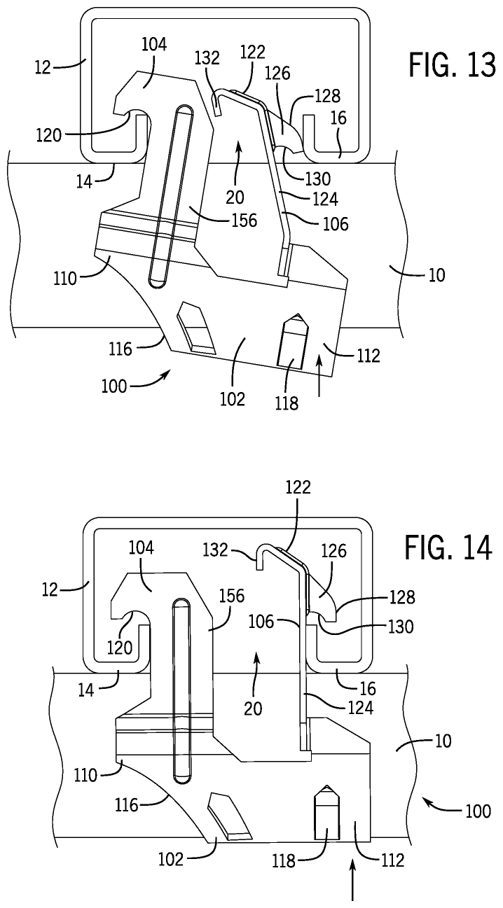

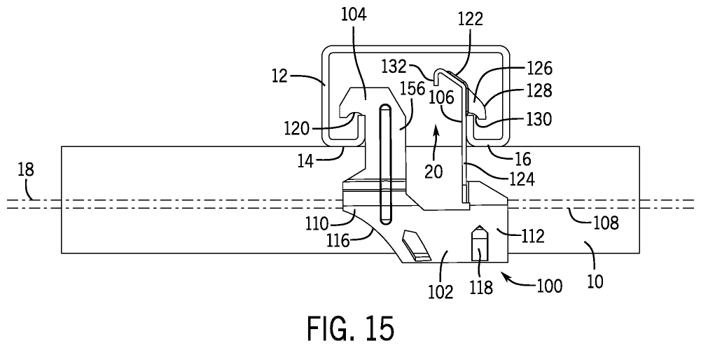

The user then pivots the clip 100 relative to the cylindrical object 10 and the strut channel 12 (e.g., about the first reentrant lip 14) to contact the guiding surface 122 of each of the arms 106 with the second reentrant lip 16 (FIG. 12). The user urges the continued rotation of the clip 100 (e.g., by pushing the clip body 102 towards the strut 12), to contact the barb 126 of each of the arms 106 with the second reentrant lip 16 of the strut channel 12 (FIG. 13). For example, in response to manually applied force from a user, the arms 106 may deform towards the hooks 104, so that the barbs 126 move into contact with the strut 12. The user then urges the barbs 126 beyond the second reentrant lip 16, allowing the arms 106 to resiliently respond and position the retention pockets 130 of the barbs 126 in line with the second reentrant lip 16 (FIG. 14). The user can then release the clip 100, with the barbs 126 and the contact edges 120 securing the clip 100 (and the cylindrical object 10) relative to the strut 12. Further, release of the clip 100 generally may also release the at least one spring grip 118, which may have been urged against the cylindrical object 10 by the user during the insertion of the barbs 126 beyond the second reentrant lip 16. This release of the spring grip 118, in some cases, can bias the clip body 102 in the second direction and thereby seat the retention pockets 130 of the barbs 126 against the second reentrant lip 16 (FIG. 15). The spring grip 118 can also help to prevent axial movement of the cylindrical object 10 relative to the clip 100, including, in some cases, by partially penetrating into a surface of the cylindrical object 10.

In the final securing position, the clip axis 108 is parallel to the longitudinal axis 18 of the cylindrical object 10 (FIGS. 1 and 15), and the clip body 102 extends generally in parallel with an outer surface of the cylindrical object 10. In other embodiments, however, other configurations are possible.

Further, as generally discussed above, the arms 106 can engage lips of a strut laterally to the outside (at least in part) of the hooks 104. In this regard, the relatively close spacing of the hooks 104 may help users to relatively easily align and engage both of the hooks 104 with the lip 14 as well as guide the rotating movement of the clip 100 to move the second end thereof toward the strut 12 for engagement of the arms 106. Additionally, the relatively wider spacing of the arms 106, and the corresponding lateral offset of the arms 106 from the hooks 104, can contribute to a more distributed and secure overall engagement of the clip 100 with the strut 12.

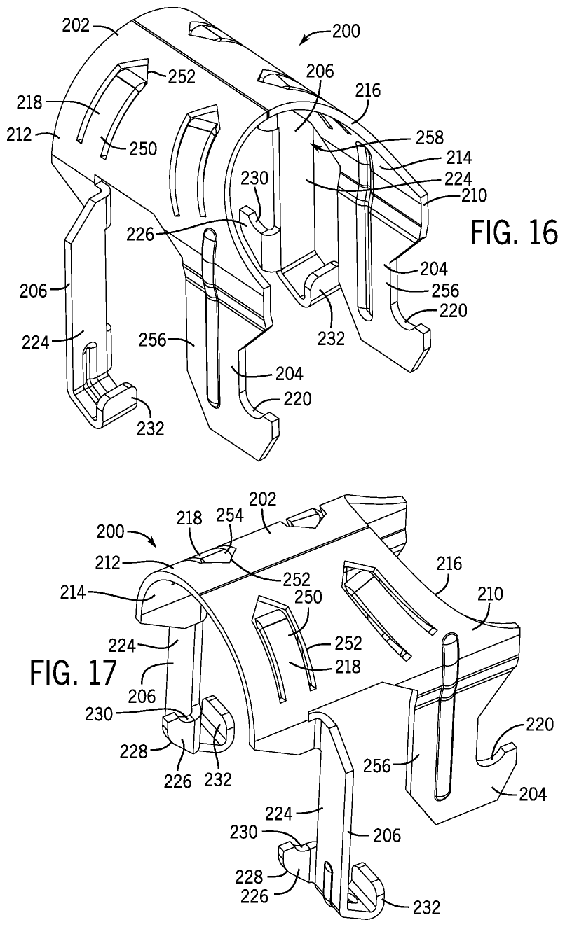

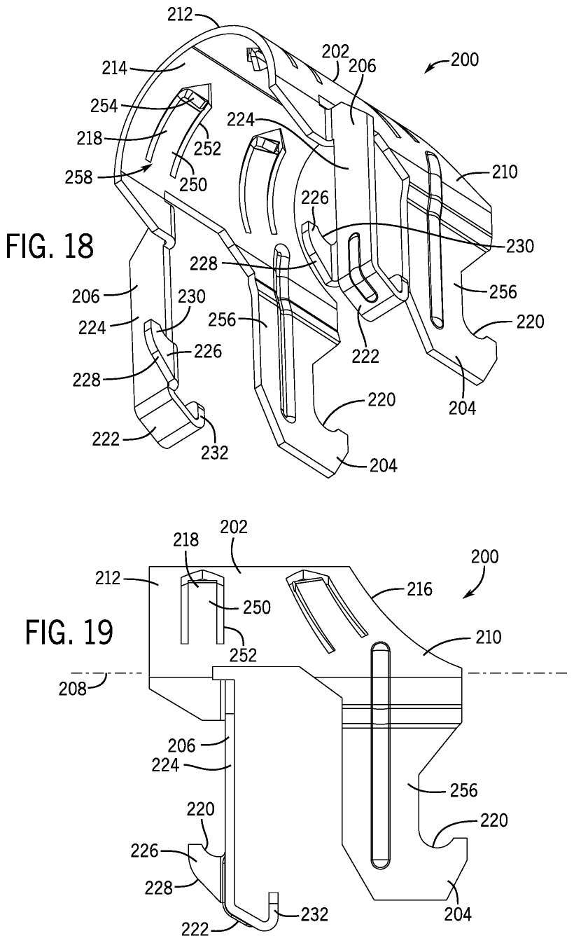

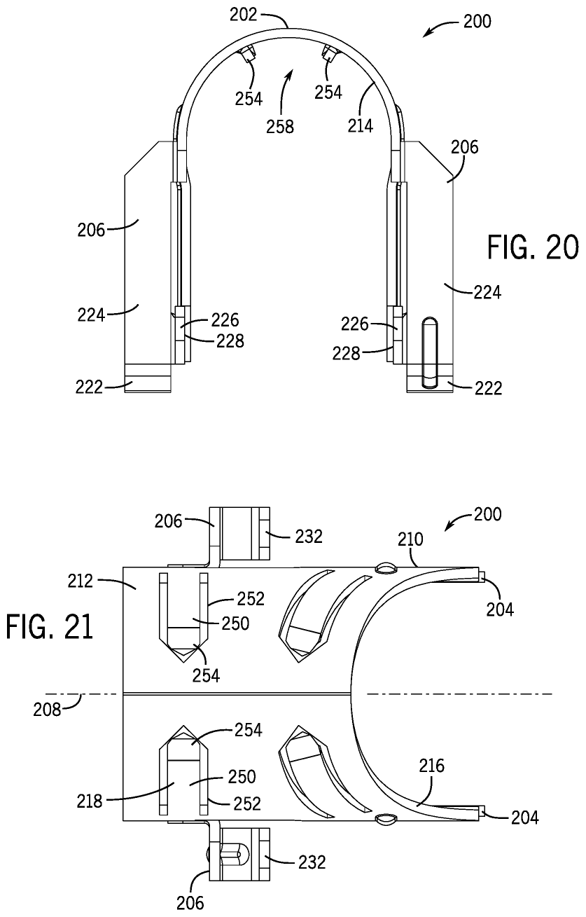

FIGS. 16 through 21 illustrate another embodiment of a clip 200 according to the invention, as also can used to secure a cylindrical object to a strut channel (e.g., the cylindrical object 10 and the strut channel 12 shown in FIG. 1). In many aspects, the clip 200 is similar to the clip 100 described above and similar numbering in the 200 series is used for the clip 200. For example, the clip 200 has a clip body 202 with a first end 210 with a notch 216; a second end 212; a clip axis 208; an inner surface 214 defining a saddle 258; spring grips 218; a set of hooks 204 with contact edges 220 and hook connecting portions 224; and a set of arms 206 with guiding surfaces 222, arm connecting portions 224, barbs with engagement edges 228 and retention pockets 220, and tabs 232. The clip 200 is also configured to be moved from an installation configuration to a support configuration and to be retained in the support configuration through the engagement of the sets of hooks 204 and the sets of arms 206 with the reentrant lips 14, 16 of the strut channel 12.

In some aspects, however, the clips 100, 200 differ from each other. For example, although, like the spring grips 118, the spring grips 218 are integrally formed with the clip body 202 and include a resilient tab 250 and a tooth 254 that extends inward from a closed slot 252 in the clip body 202, the spring grips 218 extend away from the sets of hooks and arms 104, 106. Depending on the installation requirements, more or less spring force provided by the spring grips may be desired. The arrangement of the spring grips 218 can provide a spring force that acts on the retained cylindrical object 10 that is closer to alignment, or in parallel, with the first direction, whereas the spring grips 118 are oriented at an angle closer to 45 degrees relative to the first direction. The more aligned spring force increases the amount of force needed to install the clip 200 around the cylindrical object 10 and to the strut channel 12 and also increases the force acting on the cylindrical object 10 when secured between the clip 200 and the strut channel 12. Other embodiments can include more or fewer spring grips or spring grips having different sizes or orientations to provide more or less spring force as desired.

Thus, embodiments of the invention can provide improved fastener-free securing of a cylindrical object to a strut channel. In some embodiments, for example, a clip can have a hook engaging one of the reentrant lips of the strut channel and a barb engaging the other of the reentrant lips of the strut channel, with the cylindrical object retained between the clip and the strut channel. The clip can be configured to engage the strut channel on one reentrant lip and rotate relative to the strut channel to engage the other reentrant lip.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A clip for supporting a cylindrical object with a longitudinal axis on a strut channel with a pair of reentrant lips, the clip comprising:
a clip body extending along a clip axis and having a first end with a notch and a second end, the notch being sized to receive a cylindrical object during installation of the clip to the strut channel when the clip body is positioned around the cylindrical object with the clip axis obliquely angled relative to a longitudinal axis of the cylindrical object; and
a first set of arms extending in a first direction from the first end of the clip body, with each arm of the first set including a first hook adapted to engage a first reentrant lip of a strut channel when the cylindrical object is received in the notch; and
a second set of arms extending in the first direction from the second end of the clip body, each arm of the second set being resiliently flexible to be moved into engagement with a second reentrant lip of the strut channel by contact with the strut channel as, with the first set of arms engaging the first reentrant lip, the clip body is rotated to move the second end of the clip body toward the strut channel.

2. The clip of claim 1, wherein each arm of the second set includes a second hook adapted to engage the second reentrant lip of the strut channel.

3. The clip of claim 2, wherein each arm of the second set defines a guiding surface that faces away from the clip body and is angled obliquely relative to the clip axis to contact the second reentrant lip and deflect the respective arm of the second set around the reentrant lip as the second end of the clip body is moved toward the strut channel.

4. The clip of claim 3, wherein the guiding surface extends from a distal end of the respective arm of the second set and onto the respective second hook.

5. The clip of claim 2, wherein each arm of the first set of arms is substantially planar between the respective first hook and the clip body and each arm of the second set of arms is substantially planar perpendicularly to the first set of arms between the respective second hook at the clip body.

6. The clip of claim 5, wherein each arm of the first set of arms is substantially planar tangentially to an adjacent plane of the clip body.

7. The clip of claim 2, wherein each of the second hooks has an arcuate contact edge adapted to pivotably engage the second reentrant lip of the strut channel.

8. The clip of claim 1, wherein a distal end of each arm of the second set includes a tab extending toward the clip body to receive a hand tool inserted into the strut channel to release the second set of arms from the second reentrant lip of the strut channel.

9. The clip of claim 1, wherein, from a perspective in parallel with the clip axis, the second set of arms extend laterally to at least partly engage the second reentrant lip of the strut at locations that are laterally to the outside of locations at which the first set of arms engage the first reentrant lip of the strut.

10. A clip for supporting a cylindrical object with a longitudinal axis to a strut channel with a pair of reentrant lips, the clip comprising:
a clip body extending along a clip axis configured to be parallel to a longitudinal axis of a cylindrical object secured by the clip body to a strut channel, the clip body having a first end and a second end;
a set of hooks, including a first hook and a second hook, extending from the first end of the clip body in a first direction; and
a set of arms, including a first arm and a second arm, extending from the second end of the clip body in the first direction;
the set of arms being configured to be bendable toward the first end of the clip body along the direction of the clip axis under contact with the strut channel as the clip body is rotated toward an installed orientation on the strut channel; and
the set of hooks being configured to be rigid against bending toward the second end of the clip body along the direction of the clip axis under contact with the strut channel as the clip body is rotated toward the installed orientation.

11. The clip of claim 10, wherein each of the first and second arms have an arm connecting portion connecting the first and second arms to the clip body, each of the arm connecting portions have a substantially planar arm connecting portion planar orientation;
wherein each of the first and second hooks have a hook connecting portion connecting the first and second hooks to the clip body, each of the hook connecting portions have a substantially planar hook connecting portion planar orientation; and
wherein the arm connecting portion planar orientations are perpendicular to the hook connecting portion planar orientations.

12. The clip of claim 10, wherein the clip body has a saddle that extends along the clip axis between the first and second ends of the clip body; and
wherein the first end of the clip body has a notch that extends into the saddle with a concave profile, the notch being configured to receive the cylindrical object during installation of the clip to the strut channel when the clip body is positioned with the cylindrical object between the first hook and the second hook and the clip axis orientated at an angle other than zero relative to the longitudinal axis.

13. The clip of claim 12, wherein the saddle defines a saddle radius corresponding to a radius of the cylindrical object and the notch extends into the saddle in the direction of the clip axis by at least the saddle radius.

14. The clip of claim 10, wherein the first and second arms are configured to be bent toward the first and second hooks by contact with a reentrant lip of the strut channel during installation, then spring back to engage an interior surface of the reentrant lip to secure the cylindrical object to the reentrant lip.

15. The clip of claim 14, further comprising at least one spring clip extending inward from a saddle of the clip body and adapted to make biasing contact with the cylindrical object when the clip is installed on the strut channel and the cylindrical object is secured therebetween.

16. The clip of claim 15, wherein each arm has a barb extending therefrom adapted to engage a reentrant lip of the strut channel to secure the cylindrical object to the strut channel; and
wherein each of the barbs has a retention pocket configured to receive the reentrant lip therein when the spring clip biases the clip against the cylindrical object.

17. The clip of claim 16, wherein the retention pocket is arcuate.

18. A method for securing a cylindrical object with a longitudinal axis to a strut channel with a strut axis, the strut channel having an open side with a first reentrant lip and a second reentrant lip that extend in parallel with the strut axis, the method comprising:
positioning the cylindrical object across and adjacent the open side of the strut channel, with the longitudinal axis perpendicular to the strut axis;
aligning an integrally formed clip with the cylindrical object, with a first set of arms that depend from a first end of a clip body of the clip on opposing sides of the cylindrical object;
engaging first hooks of the first set of arms with the first reentrant lip of the strut channel, with the cylindrical object received within a notch that extends axially into the clip body, and with a clip axis defined by the clip body obliquely angled relative to the longitudinal axis of the cylindrical object;
with the first hooks engaged with the first reentrant lip, rotating the clip relative to the cylindrical object, about the engagement of the first hooks with the first reentrant lip, to move a second end of the clip body toward the strut channel and cause a second set of arms to be resiliently flexed toward the first end of the clip body by contact with the strut channel to be moved into engagement with the second reentrant lip to secure the cylindrical object to the strut channel; and
engaging a set of arms extending from the second end of the body with the second reentrant lip of the strut channel.

19. The method of claim 18, wherein engaging the first hooks with the first reentrant lip include contacting an arcuate guidance surface of at least one hook in the set of hooks with the first reentrant lip and maintaining contact between the arcuate guidance surface and the first reentrant lip while rotating the clip relative to the cylindrical object to secure the cylindrical object to the strut channel.

20. The method of claim 18, wherein the arcuate guidance surface is a concave surface facing toward the clip body and remains engaged with the first reentrant clip to secure the cylindrical object to the strut channel cooperatively with the engagement between the second set of arms and the second reentrant lip.
